(19) United States
(12) Patent Application Publication
(10) Pub. No.: US 2010/0289798 A1
(43) Pub. Date: Nov. 18, 2010

(54) IMAGE PROCESSING METHOD AND IMAGE PROCESSING APPARATUS

(75) Inventors: Yasuhiro Furuta, Shimosuwa-machi (JP); Yasuhisa Yamamoto, Kitakyushu-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/778,992

(22) Filed: May 12, 2010

(30) Foreign Application Priority Data
May 13, 2009 (JP) 2009-116957
Sep. 15, 2009 (JP) 2009-213431
Apr. 9, 2010 (JP) 2010-090154

(51) Int. Cl. G06T 17/00

(52) U.S. Cl. 345/419

(57) ABSTRACT

An image processing method includes: obtaining image portrayal information representing a relationship between coordinates of a rendered image obtained by performing rendering with a texture attached to a 3-dimensional model and coordinates of the texture and a relationship between colors of each pixel of the rendered image and colors of each pixel of the texture; and compressing the image portrayal information representing a relationship between coordinates of the rendered image and coordinates of the texture using a linear compression scheme.

### BACKGROUND

1. Technical Field

The present invention relates to an image processing method and an image processing apparatus for processing image data used to perform rendering by attaching textures.

2. Related Art

In the past, as an image processing method used to perform rendering by attaching textures, there were proposed a method of rendering a 3-dimensional model in real-time and displaying it (e.g., refer to JP-A-07-152925) or a method of creating and storing a bitmap image by rendering a 3-dimensional model in advance and reading the bitmap image to display it.

In the former method, a high computation power is required because the rendering process needs to be performed within a shorter period than that of a display period of a display screen. Therefore, depending on the computer used, the computation power may be insufficient, and high-quality rendering such as ray tracing may be impossible. Meanwhile, in the latter method, since the bitmap image is displayed after high-quality rendering is performed in advance to create the bitmap image, a high-quality image can be displayed. However, in this state, another texture may not be used as a replacement thereafter. In addition, such image data have a large size and require efficient management depending on the capacity of the mounted memory.

An image processing method and an image processing apparatus according to embodiments of the invention are to efficiently manage a rendering image of a 3-dimensional model.

For this purpose, the following characteristics are provided in an image processing method and an image processing apparatus according to embodiments of the invention.

### SUMMARY

According to an aspect of the invention, there is provided an image processing method including: obtaining image portrayal information representing a relationship between coordinates of a rendered image obtained by performing rendering with a texture attached to a 3-dimensional model and coordinates of the texture and a relationship between colors of each pixel of the rendered image and colors of each pixel of the texture; and compressing the image portrayal information representing a relationship between coordinates of the rendered image and coordinates of the texture using a linear compression scheme.

In this image processing method according to an embodiment of the invention, at least image portrayal information representing a matching relationship between coordinates of the rendered image and coordinates of the texture out of image portrayal information representing a matching relationship between the texture and the rendered image is compressed using a linear compression scheme. As a result, the rendered image is effectively managed while suppressing degradation of the image quality.

In this image processing method according to an embodiment of the invention, image portrayal information representing a matching relationship between colors of each pixel of the rendering image and colors of each pixel of the texture may be compressed using a JPEG compression scheme.

In this image processing method according to an embodiment of the invention, data may be compressed by linearly approximating any one of the coordinates of the rendered image or the coordinates of the texture using a triangulation. As a result, it is possible to increase a compression rate using a relatively simple and easy processing while suppressing degradation of the image quality.

In this image processing method according to an embodiment of the invention, the rendering may be performed by attaching a predetermined pattern where a different gray-scale value is set for each of the coordinates as the texture to the 3-dimensional model, a relationship between the coordinates of the rendered image and the coordinates of the texture may be established by analyzing the rendered image obtained as a bitmap image through the rendering and stored as the image portrayal information, and when a desired texture is displayed as an image, the desired texture may be arranged and displayed on the rendered image based on the stored image portrayal information. As a result, it is possible to display an image obtained by rendering a 3-dimensional model by replacing a desired texture, and it is possible to reduce a processing burden in comparison with a method of rendering and displaying the 3-dimensional model in real-time. In this case, the image may be portrayed on a frame basis and displayed as a moving picture. In this image processing method according to an embodiment of the invention, the matching relationship may be derived by specifying corresponding coordinates having a predetermined pattern from gray-scale values of each of the coordinates of the rendered image. In this image processing method according to an embodiment of the invention, the number of the predetermined patterns may be the same as a bit number obtained by representing the coordinates of the texture as a binary number, each of the patterns may correspond to each bit obtained by representing coordinates of each pattern as a binary number, and a gray-scale value of each of the coordinates of each pattern may be set to a value corresponding to the corresponding bit number. As a result, it is possible to more accurately establish the matching relationship. In this case, the binary number may be a gray code (reflected binary number). As a result, since it is always only a single bit that changes when advancing to the neighboring coordinates, it is possible to suppress erroneous data that may be obtained due to the errors in the gray scale value of the image. In this image processing method according to an embodiment of the invention, the rendering may be performed by attaching, to the 3-dimensional model, a first solid painting pattern obtained by performing solid painting using a minimum gray-scale value in addition to a matching relationship establishment pattern for establishing a matching relationship between coordinates of the rendered image and coordinates of the texture as a predetermined pattern, a bias value which is a gray-scale value of the first solid painting pattern in the rendered image may be stored as the image portrayal information representing a relationship between the colors of each pixel of the rendered image and colors of each pixel of the texture, and the rendered image may be displayed by converting the gray-scale value of the desired texture into the gray-scale value of the rendered image by offsetting the gray-scale value of the desired texture based on the stored bias value. As a result, it is possible to create a reflection that does not depend on the original texture out of the effects of the 3-dimensional model rendering. In this case, the bias value may be compressed using a linear compression scheme. Furthermore, in this image processing method according to an embodiment of the invention, the rendering may be performed by attaching, to the 3-dimensional model, a first solid painting pattern obtained by performing a first solid painting using a minimum gray-scale value and a second solid painting pattern obtained by performing a second solid painting using a maximum gray-scale value in addition to a matching relationship establishment pattern for establishing a relationship between coordinates of the rendered image and coordinates of the texture as the predetermined pattern, a gain which is a difference between gray-scale values of the first and second solid painting patterns in the rendered image may be computed and stored as the image portrayal information representing a matching relationship between colors of each pixel of the rendered image and colors of each pixel of the texture, and the gray-scale value of the desired texture may be converted into the gray-scale value of the rendered image based on the stored gain and displayed. As a result, it is possible to reflect influence on the gray-scale value of the original texture out of the effects of the 3-dimensional model rendering. In this case, when the rendered image is displayed by arranging n textures (where n is a natural number) thereon, the rendering may be performed by setting n sets including (n−1) first solid painting patterns and a single second solid painting pattern and attaching, to the 3-dimensional model, each set including a first set group in which an area where the second solid painting pattern is attached to the 3-dimensional model is different for each set and a second set including n first solid painting patterns, and a texture area where the texture is attached to the 3-dimensional model may be specified by comparing, for each set of the first set group, gray-scale values of each rendered image obtained by performing the rendering for each set of the first set group with gray-scale values of the rendered image obtained by performing the rendering for the second set, and the gain may be computed for the specified texture area. As a result, it is possible to more readily specify the texture area. In addition, when the texture and the rendered image include a plurality of color components (e.g., three colors), the rendering may be performed by attaching the first set group and the second set to the 3-dimensional model for each color component, and the gain may be computed for each color component.

According to another aspect of the invention, there is provided an image processing apparatus including: an image portrayal information obtainment unit that obtains image portrayal information representing a matching relationship between coordinates of a rendered image obtained by performing rendering with a texture attached to a 3-dimensional model and coordinates of the texture and a matching relationship between colors of each pixel of the rendered image and colors of each pixel of the texture; and a compression unit that compresses the image portrayal information representing coordinates of the rendered image and coordinates of the texture using a linear compression scheme.

In this image processing apparatus according to an embodiment of the invention, out of the image portrayal information representing a matching relationship between the texture and the rendered image, at least image portrayal information representing a matching relationship between coordinates of the rendered image and coordinates of the texture is compressed using a linear compression scheme. As a result, it is possible to effectively manage the rendered image while suppressing degradation of the image quality.

### BRIEF DESCRIPTION OF THE DRAWINGS

FIGS. 1A to 1D illustrate a special texture.

FIGS. 2A to 2D illustrate a special texture.

FIG. 3 illustrates a non-texture area and a texture area.

FIG. 4 is a schematic diagram illustrating a configuration of a computer used in the image processing method.

FIG. 5 is a flowchart illustrating an example of a special texture creation process.

FIG. 6 illustrates an example of a special texture.

FIG. 7 illustrates a process of rendering a special texture for each set.

FIG. 8 is a flowchart illustrating an example of a rendered image analysis process.

FIG. 9 illustrates a bias B_{c,t}(x, y) and a gain G_{c,t}(x, y).

FIG. 10 is a flowchart illustrating an example of a compression process.

FIG. 11 is a flowchart illustrating an example of a linear compression process.

FIGS. 12A and 12B illustrate a relationship between a plane α and a pixel C.

FIGS. 13A and 13B illustrate a relationship between a plane β and a pixel P.

FIG. 14 illustrates a triangulation process of a point set G={A, B, C, P}.

FIG. 15 illustrates a linear compression process.

FIG. 16 illustrates three replacement textures.

FIG. 17 illustrates an example of a slideshow display of the replacement textures.

FIG. 18 illustrates a special texture according to a modified example.

FIG. 19 illustrates a rendering process using a special texture according to modified example.

FIG. 20 illustrates a special texture according to a modified example.

### DESCRIPTION OF EXEMPLARY EMBODIMENTS

Hereinafter, embodiments of the invention will be described.

An embodiment of the invention is a technology relating to a rendering process in which a 2-dimensional texture is attached to a 3-dimensional structure, and a 2-dimensional image (hereinafter, referred to as a rendered image) is generated representing a state of the attached 3-dimensional structure viewed from a predetermined direction. In other words, an embodiment of the invention provides a compression scheme for efficiently managing image data treated when the rendering process is performed. This compression scheme is applied when the rendering process creates a rendered image in which a texture area where texture is attached and a non-texture area where the texture is not attached simultaneously exist.

According to an embodiment of the invention, in order to allow the aforementioned rendering process to be performed with a small amount of resources, a coefficient for creating the rendered image from the texture by comparing the rendered image after the texture is attached to the 3-dimensional model is previously defined as image portrayal information.

This coefficient is a formula defining a matching relationship between a position of a pixel of arbitrary texture and a position of a pixel of a rendered image and change of a color in each pixel and computed through the following processes.

### A. Specifying Attached Textures

### B. Specifying Influence of the Rendering Process on the Luminance, and

C. Specifying a Matching Relationship at the position of the Pixel

This process is performed using a predetermined pattern of textures (hereinafter, referred to as a special texture) created to specify the aforementioned coefficient instead of an arbitrary texture. In addition, the size of the special texture (the number of pixels in row and column directions) is set to be the same as that of the aforementioned 2-dimensional texture. Now, the processes A to C will be described.

### A. Specifying Attached Textures

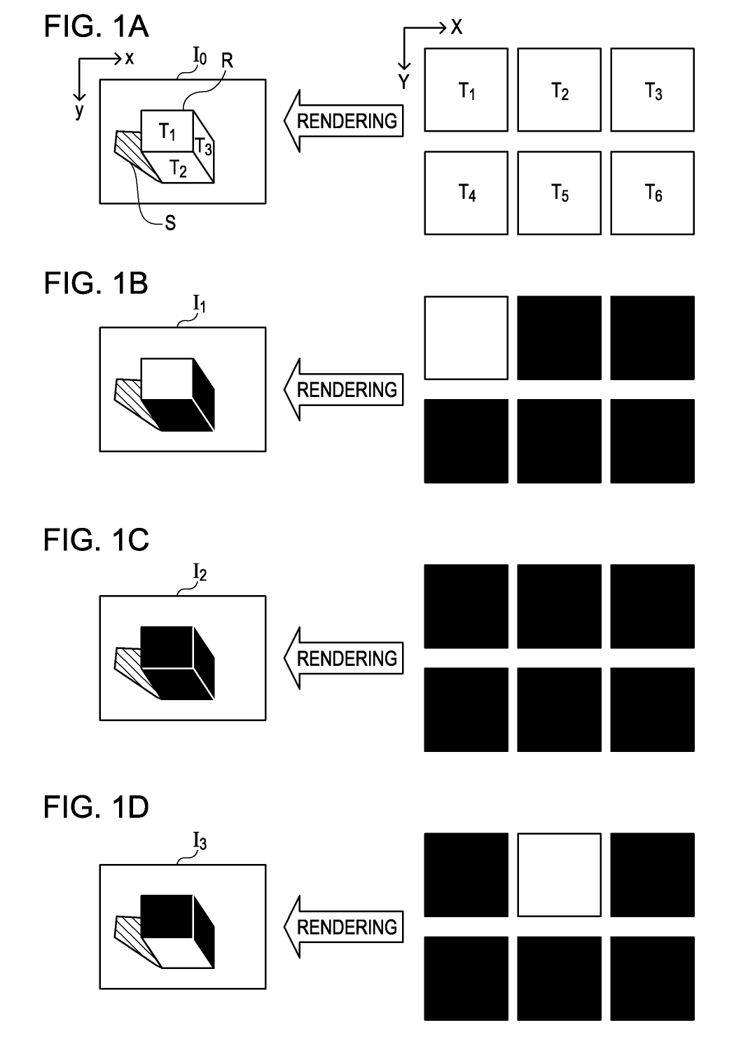

FIG. 1A illustrates a schematic of the rendering process. In the rendering process according to an embodiment of the invention, it is assumed that n 2-dimensional textures (where n is any natural number) are attached to each surface of a virtual 3-dimensional structure, and the 2-dimensional image obtained by viewing the 3-dimensional structure from a predetermined direction in the state in which the textures are attached is defined as the rendered image. Therefore, in the rendered image, a maximum of n textures can be viewed depending on the direction of the 3-dimensional structure. In FIG. 1A, I₀ denotes the rendered image when 2-dimensional textures T₁ to T₆ are attached to a virtual rectangular body R, and three textures T₁ to T₃ are viewed out of the six textures T₁ to T₆. In addition, in the example shown in FIG. 1A, it is assumed that the virtual rectangular body R is laid on a pedestal, and a shade S of the rectangular body R is formed on the pedestal.

Since such a rendering process is realized by attaching a particular texture to a particular surface of the 3-dimensional structure, the coordinates of the rendered image necessarily correspond to the coordinates of a single texture, but do not correspond to the coordinates of a plurality of textures. In other words, the coordinates of the rendered image correspond to the coordinates of the texture one by one. In this regard, according to an embodiment of the invention, a set of n special textures are created in which a particular single special texture is white and remaining (n−1) special textures are black, and furthermore, another n special textures are created in which all of the n textures are black. Then, the position of the rendered image corresponding to the aforementioned single white special texture is specified by comparison of the rendered images. In this case, the white special texture corresponds to a second solid painting pattern, and the black special texture corresponds to a first solid painting pattern.

FIGS. 1B to 1D illustrate exemplary special textures attached by replacement to the textures T₁ to T₆ of FIG. 1A in the six rectangles shown in the right side. FIG. 1B shows an example in which only the special texture corresponding to the texture T₁ is white, and the special textures corresponding to the textures T₂ to T₆ are black. FIG. 1C shows an example in which the special textures corresponding to the textures T₁ to T₆ are black. In addition, the reference numerals I₁ and I₂ denote the rendered images created by the rendering process based on the special textures shown in FIGS. 1B and 1C.

According to an embodiment of the invention, the position of the rendered image corresponding to the special texture of the second solid painting pattern is specified by comparing the rendered images I₁ and I₂ created by the aforementioned process. That is, if the luminance of the rendered images I₁ and I₂ is compared for each pixel of the rendered images, a difference in the luminance is generated in the pixel attached to the special texture of the second solid painting pattern, but is not generated in the pixel attached to the special texture of the first solid painting pattern. In this regard, for example, a process of determining whether or not the luminance of the rendered image I₁ is larger than the luminance of the rendered image I₁ is performed for each pixel. If the luminance of the rendered image I₁ is larger than the luminance of the rendered image I₂, it can be determined that the special texture of the second solid painting pattern is attached to the determined pixel.

In other words, the position of the rendered image corresponding to the texture T₁ is specified by comparing the rendered image I₁ obtained by performing the rendering process using the texture T₁ as the special texture of the second solid painting pattern as shown in FIG. 1B with the rendered image I₂ obtained by performing the rendering process using all textures as the special texture of the first solid painting pattern as shown in FIG. 1C. Similarly, the position of the rendered image corresponding to the texture T₂ is specified by comparing the rendered image I₂ with the rendered image I₃ obtained by performing the rendering process using the texture T₂ as the special texture of the second solid painting pattern as shown in FIG. 1D. Accordingly, when the aforementioned process is performed for each of the rendered images obtained by rendering a group of special textures in which any one of the n textures is white and the remaining textures are black, the positions where the n textures are attached are specified.

### B. Specifying Influence of the Rendering Process on the Luminance

Next, the influence of the rendering process on the luminance is specified for each pixel of the rendered image. In the rendering process shown in FIG. 1A, the luminance value of the rendered image is specified considering that predetermined influence is given to light from a light source set in a virtual position or a shade caused by the shape of the corresponding 3-dimensional structure or the like after attaching the textures T₁ to T₆ to a virtual 3-dimensional structure. Therefore, the predetermined influence can be defined for each pixel of the rendered images. Furthermore, according to an embodiment of the invention, it is considered that the luminance value of each pixel of the rendered image is defined by a sum of the integer components (hereinafter, referred to as a bias B) that do not depend on the textures T₁ to T₆ and a proportional component (hereinafter, referred to as a gain G) proportional to the luminance of the textures T₁ to T₆.

In this regard, it is possible to specify the influence of the rendering process on the luminance by specifying the bias B and the gain G for each pixel of the rendered image. This influence can be specified using the rendered image I₂ obtained by performing the rendering process by replacing the special texture of the first solid painting pattern with all of the n textures as shown in FIG. 1C and the rendered images I₁ and I₃ obtained by performing the rendering process by replacing a particular single one of the n textures with the special texture of the second solid painting pattern and replacing the remaining textures with the special texture of the first solid painting pattern as shown in FIGS. 1B and 1D.

Specifically, in the rendered image I₂ shown in FIG. 1C, all of the n textures are special textures of the first solid painting pattern. In each pixel of the rendered image created by attaching the special texture of the first solid painting pattern to the virtual 3-dimensional structure, if a meaningful luminance value (larger than zero) is obtained, it is considered that this luminance value is meaningful without influence from the original texture. In this regard, it is possible to define, as the bias B, the luminance value of each pixel of the rendered image created by attaching the special texture of the first solid painting pattern to the virtual 3-dimensional structure.

Meanwhile, it is possible to specify the gain G by subtracting the bias B from the luminance value of each pixel of the rendered image corresponding to a portion where the special texture of the second solid painting pattern is attached. In this regard, the gain G of each pixel is specified by subtracting the bias B from each pixel of the rendered image corresponding to a position where the special texture of the second solid painting pattern is attached.

### C. Specifying a Matching Relationship at the Position of the Pixel

Next, a matching relationship at the position of the pixel before and after the rendering is specified. That is, a matching relationship between the position of each pixel in the texture and the position of each pixel in the rendered image is specified. This matching relationship is specified by matching the coordinates (x, y) of the rendered image with the coordinates (X, Y) of the texture based on the rendered image obtained by rendering the special texture. However, according to an embodiment of the invention, this matching relationship is specified by specifying a matching relationship between the x-coordinates and the X-coordinates and a matching relationship between the y-coordinates and the Y-coordinates, and special textures (a pattern for establishing the matching relationship) for forming the former and the latter are created.

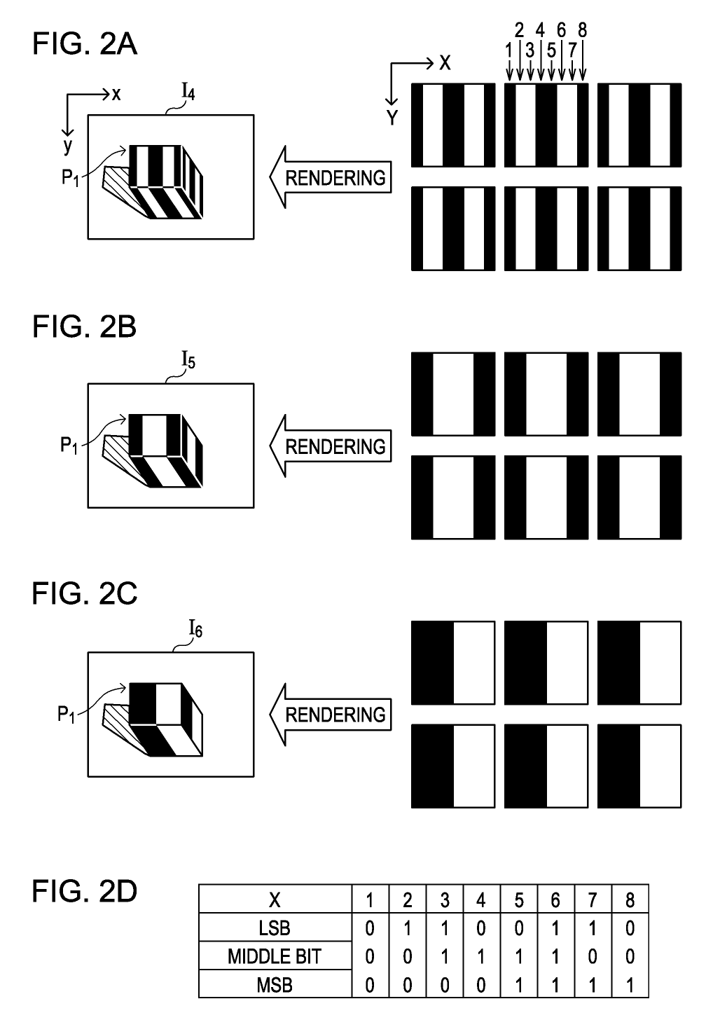

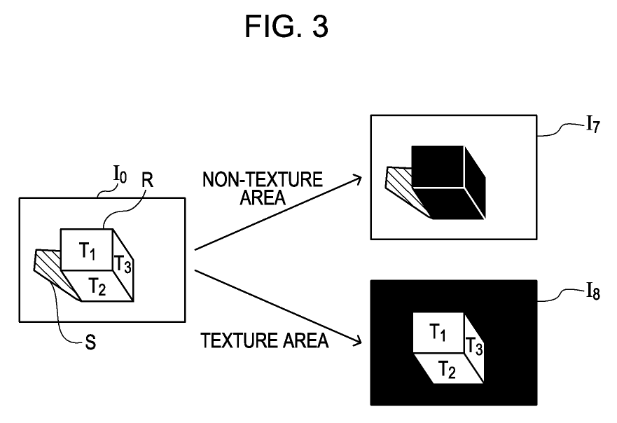

FIGS. 2A to 2C illustrate an example of the special texture created to specify the matching relationship between the x-coordinates and the X-coordinates. In the coordinates system of these drawings, positions of pixels in the horizontal direction are defined by the X-coordinates and the x-coordinates, and positions of pixels in the vertical direction are defined by the Y-coordinates and the y-coordinates. In addition, since it is assumed that both the X-coordinates and the Y-coordinates of the texture have a range of 1 to 8, both the X-coordinates and the Y-coordinates of the special texture have a range of 1 to 8. In FIG. 2A, the X-coordinates values of a single special texture are designated by arrows. The special texture created to specify the matching relationship between the x-coordinates and the X-coordinates is the same for all of the n textures. For example, FIG. 2A shows an example of the special texture created when six textures T₁ to T₆ are attached to the virtual 3-dimensional structure as shown in FIG. 1A. In the example of FIG. 2A, all the patterns of the special textures replaced with the six textures T₁ to T₆ are the same.

However, in the special textures created to specify the matching relationship between the x-coordinates and the X-coordinates, the number of the created patterns is the same as the bit number of the X-coordinates. For example, in the example shown in FIGS. 2A to 2C, since the X-coordinates value has a range of 1 to 8 and includes 3 bits, three types of special textures are created. That is, in each of FIGS. 2A, 2B, and 2C, while the special textures have different patterns, the patterns of the n special textures of FIG. 2A are the same.

According to an embodiment of the invention, the patterns of three types of the special textures are set such that a permutation of the luminance obtained by extracting the luminance of the same X-coordinates value in series from three types of the special textures is different for every X-coordinate value. For example, a permutation (black, black, black) is obtained by extracting the luminance of the X-coordinates value of 1 in the order of FIGS. 2A, 2B, and 2C, and a permutation (white, black, black) is obtained by extracting the luminance of the X-coordinates value of 2 in the order of FIGS. 2A, 2B, and 2C. As described above, when the pattern of the special texture is set such that the permutations of all X-coordinates values are different, it is possible to specify the X-coordinates value of the original special texture based on the luminance values of each of the coordinates of three types of the rendered images after the three types of special textures are rendered. For example, when the permutations of the luminance of the original special textures are specified by sequentially referencing the luminance values of each of the coordinates of three types of the rendered images, it is possible to specify the X-coordinates value of the special texture corresponding to each of the coordinates of the rendered image.

More specifically, in the example shown in FIGS. 2A to 2C, a permutation of the luminance of the original special texture specified by extracting the luminance values at the position P₁ of the rendered images I₄, I₅, and I₆ in series is (black, black, black). This permutation corresponds to the luminance of the X-coordinates value of 1 of the original special textures, and no luminance of any other X-coordinates values corresponds to this permutation. Therefore, it is possible to specify that the image of the X-coordinates value 1 of the special texture is attached to the position P₁ of the rendered image where this permutation is extracted.

In this regard, according to an embodiment of the invention, the rendering process is performed by creating n special textures having the same number of types as the bit number of the X-coordinates of the special texture. The luminance values at each position of the rendered image where any of the n textures is attached is specified through the aforementioned process A are sequentially extracted. Then, a matching relationship between the x-coordinates and the X-coordinates is specified by specifying the X-coordinates value of the original special texture based on the extracted permutation.

It is preferable that the matching relationship between the x-coordinates and the X-coordinates is specified by representing the X-coordinates value, for example, using a gray code. The special texture patterns shown in FIGS. 2A to 2C are used when the matching relationship between the x-coordinates and the X-coordinates is specified using a gray code. That is, in this example, in order to specify the matching relationship between the x-coordinates and the X-coordinates using the gray code, the pattern shown in FIG. 2A is created such that the pattern has a black color if the least significant bit value obtained by representing the X-coordinates value as the gray code is 0, or the pattern has a white color if the least significant bit value is 1. Similarly, the pattern shown in FIG. 2B is created such that the pattern has a black color if the bit (referred to as a middle bit) value immediately above the least significant bit when the X-coordinates value is represented as a gray code is 0, or the pattern has a white color if the middle bit value is 1. In addition, the pattern shown in FIG. 2C is created such that the pattern has a black color if the most significant bit value is 0, or the pattern has a white color if the most significant bit value is 1. That is, the special texture pattern shown in FIG. 2A is determined based on the value of the least significant bit when the X-coordinates value is represented as a gray code, and the special texture patterns shown in FIGS. 2B and 2C are determined based on the values of the middle bit and the most significant bit, respectively, when the X-coordinates value is represented as a gray code. In other words, in the example of FIGS. 2A to 2C, the same number of patterns as the bit number of 3 are formed while FIGS. 2A, 2B, and 2C correspond to the least significant bit, the middle bit, and the most significant bit, respectively.

FIG. 2D illustrates a process of forming the pattern. As shown in FIG. 2D, the gray code representing the X-coordinates value of 1 is (000), in which the least significant bit is 0, the middle bit is 0, and the most significant bit is 0. Therefore, the luminance of the X-coordinates value of 1 in the special texture of FIG. 2A is black, the luminance of the X-coordinates value of 1 in the special texture of FIG. 2B is black, and the luminance of the X-coordinates value of 1 in the special texture of FIG. 2C is black. Similarly, the gray code representing the X-coordinates value of 2 is (001), in which the least significant bit is 1, the middle bit is 0, and the most significant bit is 0. Therefore, the luminance of the X-coordinates value of 2 in the special texture of FIG. 2A is white, the luminance of the X-coordinates value of 2 in the special texture of FIG. 2B is black, and the luminance of the X-coordinates value of 2 in the special texture of FIG. 2C is black. By repeating the same process for the X-coordinates values 3 to 8, the patterns of FIGS. 2A to 2C are created.

As described above, if a plurality of types of special texture patterns are determined by the gray code, it is possible to determine the value obtained by representing the X-coordinates value of the original special texture as a gray code based on the luminance of the original special texture specified by the luminance values of each of the coordinates of the rendered images created from a plurality of types of the special textures. Here, the luminance of the original special texture specified by the luminance value of the rendered image may be specified by determining whether or not the value obtained by subtracting the aforementioned bias B from the luminance value of the rendered image is larger than a half (½) of the gain G. That is, when the original special texture is black, the value obtained by subtracting the bias B from the luminance value of the rendered image becomes nearly 0. When the original special texture is white, the value obtained by subtracting the bias B from the luminance value of the rendered image becomes nearly equal to the gain G. Therefore, if the value obtained by subtracting the bias B at each position from the luminance value at each position of the rendered image is larger than a half (½) of the gain G at each position, the original special texture can be considered as white. Meanwhile, if the value obtained by subtracting the bias B at each position from the luminance value at each position of the rendered image is equal to or smaller than a half (½) of the gain G at each position, the original special texture can be considered as black.

In this regard, if the rendered image is created by rendering the special texture created based on the least significant bit value when the X-coordinates value is represented as a gray code, and it is determined that the original special texture is white based on the luminance value of each of the coordinates in the corresponding rendered image, the least significant bit value of the X-coordinates value represented as a gray code at that position is set to 1. In addition, if it is determined that the original special texture is black based on the luminance value of each of the coordinates in the rendered image, the least significant bit value of the X-coordinates value represented as a gray code at that position is set to 0. It is possible to determine all of the bits of the X-coordinates values represented as a gray code corresponding to each position of the rendered image and, as a result, define the matching relationship between the x-coordinates and the X-coordinates by performing the aforementioned process for each of a plurality of types of the special textures.

For example, in the example shown in FIG. 2A, since the value obtained by subtracting the bias B(x, y) from the luminance value at the position P₁(x, y) in the rendered image I₄ is equal to or smaller than a half (½) of the gain G(x, y), it is determined that the original special texture is black. Therefore, the least significant bit of the X-coordinates value of the texture corresponding to the position P₁(x, y) becomes 0. Similarly, in the example shown in FIG. 2B, since the value obtained by subtracting the bias B(x, y) from the luminance value at the position P₁(x, y) in the rendered image I₅ is equal to or smaller than a half (½) of the gain G(x, y), it is determined that the original special texture is black. Therefore, the middle bit of the X-coordinates value of the texture corresponding to the position P₁(x, y) becomes 0. In the example shown in FIG. 2C, since the value obtained by subtracting the bias B(x, y) from the luminance value at the position P₁(x, y) in the rendered image I₆ is equal to or smaller than a half (½) of the gain G(x, y), it is determined that the original special texture is black. Therefore, most significant bit of the X-coordinates value of the texture corresponding to the position P₁(x, y) becomes 0. Therefore, the gray code representation of the X-coordinates value corresponding to the position P₁(x, y) is (0 0 0), the X-coordinate value is specified to 1.

The aforementioned process is substantially the same as the process of determining the X-coordinates value corresponding to each of the coordinates of the rendered image by specifying a permutation of the luminance of the original special texture based on the luminance value at each of the coordinates in a plurality of types of the rendered images and specifying the X-coordinates value based on the corresponding permutation. In addition, it is possible to specify the Y-coordinates value corresponding to each coordinates in the rendered image by performing the same process for the Y-coordinates values. That is, it is possible to specify the matching relationship between the y-coordinates and the gray code representation of the Y-coordinates value by performing determination such as the determination for the X-coordinates value based on the special texture obtained by rotating the patterns shown in FIGS. 2A to 2C by 90°.

It is possible to specify the coordinates (X, Y) of the texture corresponding to any coordinates (x, y) in the rendered image by performing each of the processes A to C as described above. In addition, it is possible to specify the influence of the rendering process on the luminance of any coordinates (x, y) in the rendered image. Therefore, if the information representing influence of the rendering process on the luminance and the matching relationship of the coordinates specified by each process are stored, it is possible to perform the process of creating the rendered image from any texture based on the stored information with a significantly small amount of resources. In addition, when the virtual 3-dimensional structure assumed in the rendering process or the location of the lightning is not obvious, i.e., even when only the image after the rendering process and the texture therebefore are obvious, it is possible to perform the rendering process.

According to an embodiment of the invention, as described above, the matching relationship between the rendered image and the texture before the rendering is represented as a function. That is, it is possible to create the rendered image from any texture by setting the coordinates value (x, y) of the rendered image as a variable and setting I(x, y) representing the texture attached to each coordinates value, the bias B(x, y), the gain G(x, y), and the coordinates of the texture X(x, y) and Y(x, y) as the image portrayal information.

Here, the bias B(x, y), the gain G(x, y), and the coordinates X(x, y) and Y(x, y) are functions in which the bias B(x, y), the gain G(x, y), and gray-scale values of the coordinates X(x, y) and Y(x, y) vary depending on the variables x and y. According to an embodiment of the invention, it is possible to effectively manage the rendered image while suppressing degradation of the image quality by compressing such functions. That is, the bias B(x, y) and the gain G(x, y) are compressed with a high compression rate using a JPEG compression scheme, and the coordinates X(x, y) and Y(x, y) are compressed such that degradation of the image quality is suppressed by a linear compression scheme.

Specifically, the coordinates X(x, y) represent the matching relationship between the coordinates X of the texture and the coordinates (x, y) of the rendered image, and the coordinates Y(x, y) represent the matching relationship between the coordinates Y of the texture and the coordinates (x, y) of the rendered image. Therefore, when an error occurs in the matching relationship of the coordinates due to an irreversible compression scheme, the original position where the texture is to be attached in the rendered image becomes different from the position where the texture is actually attached. Here, when this error abruptly changes between the neighboring pixels of the texture, the image quality of the rendered image is remarkably degraded. However, when this error gradually changes for each pixel of the texture, degradation of the image quality of the rendered image is suppressed.

In this regard, according to an embodiment of the invention, the coordinates X(x, y) and Y(x, y) are compressed using a linear compression scheme. That is, for example, in the JPEG compression scheme, since the compression process is performed by dividing an image into minimum coded units (MCU), a block noise for which an error abruptly changes in the boundary of the MCU may be generated. However, in the linear compression, since the compression is performed such that the gray-scale value linearly changes between neighboring pixels, this error gradually changes in each pixel of the texture even when an error occurs. Therefore, it is possible to suppress degradation of the image quality by compressing the coordinates X(x, y) and Y(x, y) using a linear compression scheme.

In addition, the linear compression can be performed using various techniques. For example, when the coordinates X(x, y) are represented as a 3-dimensional graph having a height set by the value of the coordinates X on an x-y plane, the linear compression can be realized by expressing the embossing in the height direction designated by the value of the coordinates X on this graph as an approximate embossing including polygons (e.g., triangles) on the entire surface. In addition, when the approximate embossing is defined such that triangles are formed on the entire surface, the triangles may be determined such that the projection of the triangle onto the x-y plane makes triangles divided based on Delaunay's triangulation. The approximation may be realized by incrementing the number of triangles using a triangulation until a difference between the approximate coordinates X represented as the triangle and the true value of the coordinates X is within predetermined values.

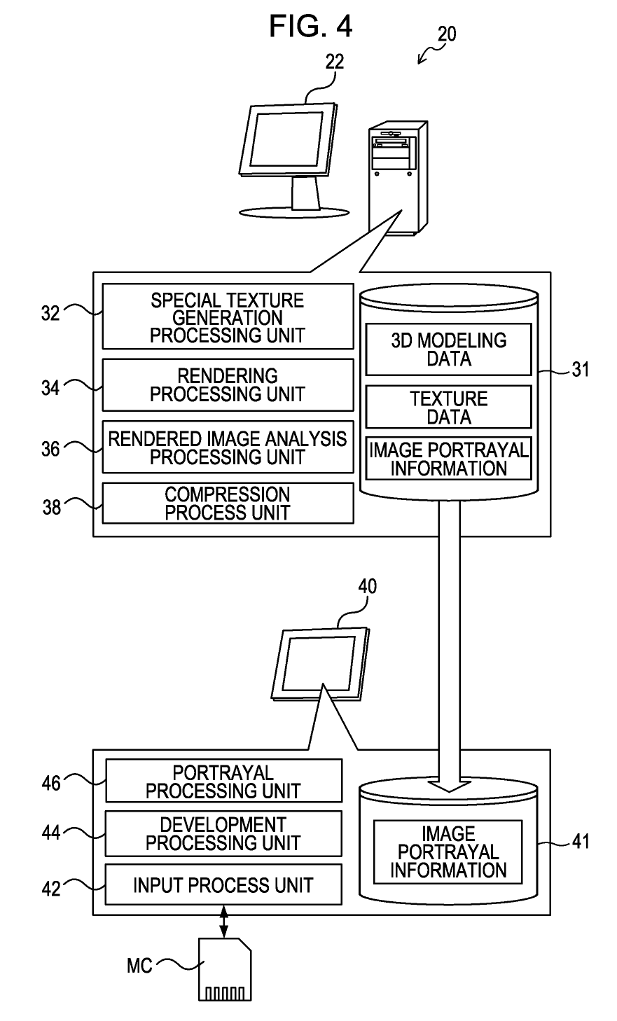

Next, embodiments of the invention will be described with reference to the accompanying drawings together with a specific example. FIG. 4 is a schematic diagram illustrating a configuration of a computer 20 and a viewer 40 used in an image processing method according to an embodiment of the invention. The computer 20 according to an embodiment of the invention is constructed of a general purpose computer including a central processing unit (CPU), a read-only memory (ROM) for storing a processing program, a random access memory (RAM) for temporarily storing data, a graphic processor unit (GPU), a hard disc drive (HDD), a display unit 22, or the like. As the functional blocks, there are included a storage unit 31 for storing 3-dimensional modeling data (hereinafter, referred to as a 3-dimensional model) expressing a virtual 3-dimensional structure, texture data attached thereto (hereinafter, referred to as a texture), or the like; a special texture creation processing unit 32 for creating pre-processing special textures attached to the 3-dimensional model; a rendering processing unit 34 for creating a bitmap image by rendering the 3-dimensional model; a rendered image analysis processing unit 36 for analyzing the rendered image as a bitmap image obtained by the rendering; and a compression processing unit 38 for compressing the created rendered image or various data obtained by the analysis of the rendered image analysis processing unit 36.

The special texture creation processing unit 32 creates the special textures attached to the 3-dimensional model rendered by the rendering processing unit 34. Specifically, the special texture creation processing unit 32 creates a white beta pattern (second solid painting pattern) having a gray-scale value of 1.0 within the gray-scale value range of 0.0 to 1.0, a black beta pattern (first solid painting pattern) having a gray-scale value of 0.0, a vertical stripe pattern (a matching relationship establishment pattern) where gray-scale values of 0.0 and 1.0 are provided alternately in a horizontal direction, a horizontal stripe pattern (a matching relationship establishment pattern) where gray-scale values of 0.0 and 1.0 are provided alternately in a vertical direction. In addition, the roles of each pattern are described below.

The rendering processing unit 34 is a processing unit operated by installing a 3-dimensional rendering software application in a computer 20. The rendering processing unit 34 displays a moving picture by reproducing the bitmap image on a frame basis with a predetermined frame rate (e.g., 30 or 60 times per second) by attaching the textures created by the special texture creation processing unit 32 to the 3-dimensional model and rendering them. According to an embodiment of the invention, the rendering process is performed using a ray tracing method in which the rendering is performed by computing reflection or refraction of light at the object surface while retracing the light from a light source.

The rendered image analysis processing unit 36 creates image portrayal information for displaying the rendered image on the viewer 40 side while freely replacing desired image data such as a photograph with the special texture by analyzing the bitmap image (rendered image) created by the rendering processing unit 34.

The compression processing unit 38 compresses the image portrayal information created through the analysis by the rendered image analysis processing unit 36. According to an embodiment of the invention, in order to suppress degradation of the image quality and increase the entire compression rate, the data are compressed using a plurality of types of compression schemes. The compression schemes are described below in detail.

The viewer 40 according to an embodiment of the invention includes: a storage unit 41 for storing the rendered image obtained by the rendering processing unit 34 of the computer 20, the image portrayal information analyzed by the rendered image analysis processing unit 36 and compressed by the compression processing unit 38, or the like; an input processing unit 42 for receiving the image data such as a photograph stored in a memory card MC; a deployment processing unit 44 for decoding (deploying) the image data input by the input processing unit 42 or the image portrayal information or the rendered image stored in the storage unit 41; and a portrayal processing unit 46 for synthesizing and portraying the image data input to the rendered image as the texture. The viewer 40 sequentially reads a plurality of image data stored in the memory card MC based on the instruction from a user while at the same time, sequentially attaching the read image data to the rendered image of the 3-dimensional model using the image portrayal information, and reproducing them.

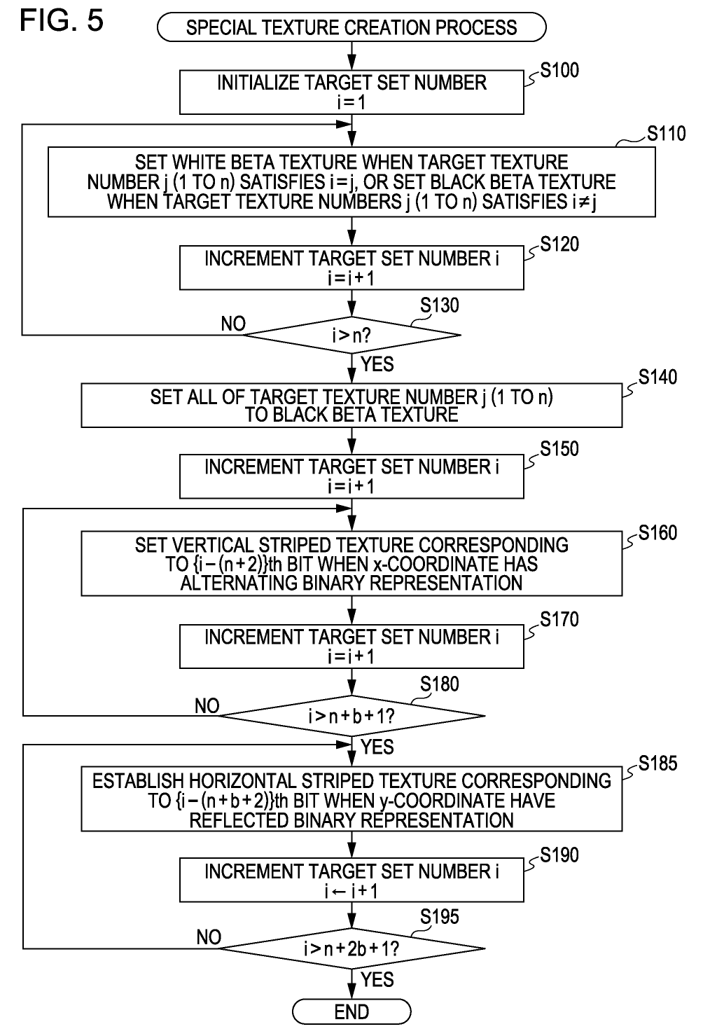

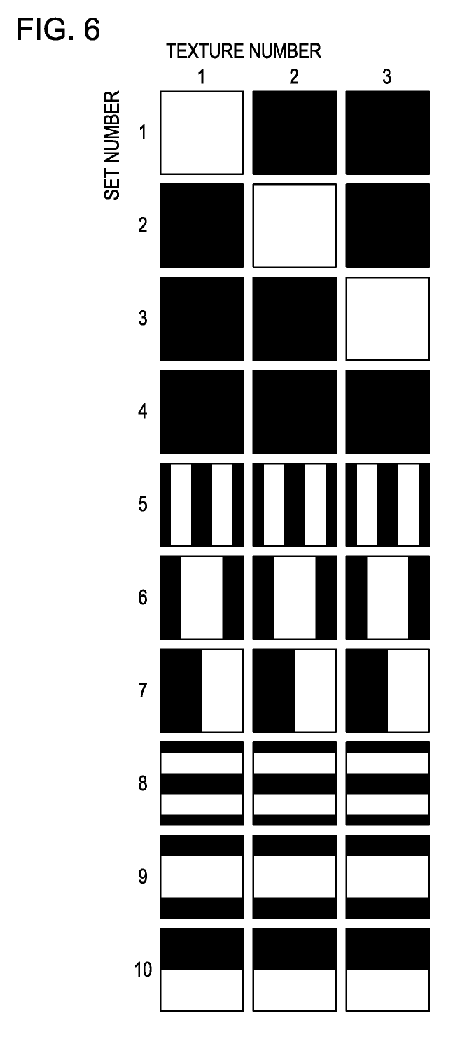

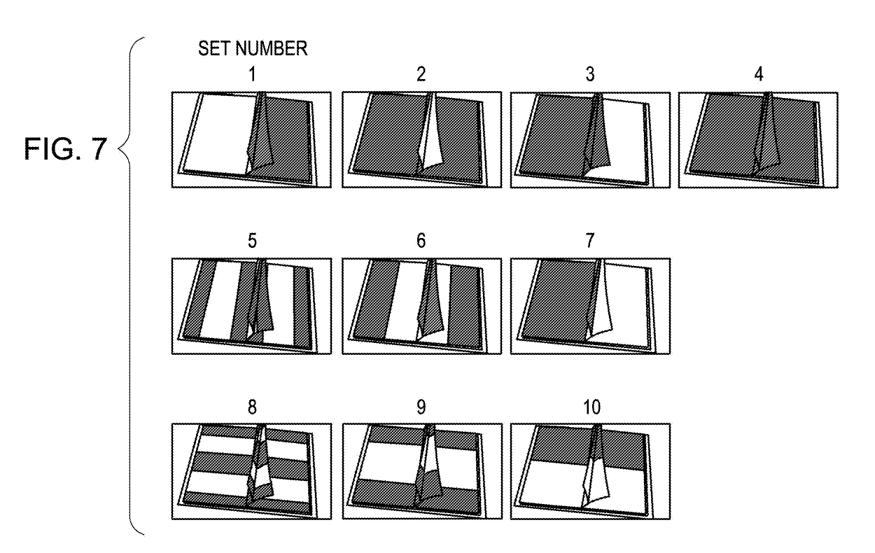

Next, operations of the special texture creation processing unit 32, the rendering processing unit 34, the rendered image analysis processing unit 36, and the compression processing unit 38 of the computer 20 and operations of the deployment processing unit 44 and the portrayal processing unit 46 of the viewer 40 according to an embodiment of the invention configured as described above will be described. First, a process in the special texture creation processing unit 32 will be described. FIG. 5 is a flowchart illustrating an example of a special texture creation process.

In the special texture creation process, first, a target set number i for specifying any one of a plurality of sets is initialized to 1 (step S100), and n special textures are created for each color component of red, green, and blue components with respect to the target set number i (step S110). The target set number i is incremented by one (step S120), and the target set number i and the value n are compared with each other (step S130). When the target set number is equal to or smaller than the value n, the process returns to step S110, and a process of creating n special textures is iterated for the next target set number i. When the target set number is larger than the value n, the process advances to the next step. Here, the process of creating the special textures for the target set number i ranged from 1 to n is performed by comparing the target texture number j and the target set number i while shifting the target texture number j from 1 to n one by one as shown in the following formula (1), creating a white beta special texture (second solid painting pattern) for the target texture number j by setting the gray-scale value of 1 to the entire coordinates (X, Y) within the gray-scale value range from a minimum value of 0.0 (black) to a maximum value of 1.0 (white) when the target texture number j and the target set number i correspond with each other, and creating a black beta special texture (first solid painting pattern) for the target texture number j by setting a gray-scale value of 0.0 to the entire coordinates (X, Y) when the target texture number j and the target set number i do not correspond with each other. Here, the reference symbol “c” in the formula (1) denotes a value corresponding to each of the red, green, and blue colors of the image data, the reference symbol “b” denotes a bit number when the coordinates of the texture are expressed as a binary number, and the reference symbol “T_{c,i,j} (X,Y)” denotes a gray-scale value of the coordinates (X, Y) of the special texture for the color component c, the target set number i, and the target texture number j (which will be similarly used hereinafter). In addition, in this case, for all of the color components, a pattern by which a maximum gray-scale value is set to the entire coordinates is called a white beta pattern, and a pattern by which a minimum gray-scale value is set to the entire coordinates is called a black beta pattern (which will be similarly used hereinafter).

If i=j, T_{c,i,j}(X,Y)=1.0 or

If i≠j, T_{c,i,j}(X,Y)=0.0 (1)

where, c=1 to 3, j=1 to n, X=1 to 2^{b}, Y=1 to 2^{b}

If the special textures having a value of 1 to n (a first set group consisting of n sets) are created for the target set number i, then n special textures are created for each color component of the target set number i having a value of (n+1) (step S140)(a second set), and the target set number i is incremented by 1 (step S150). Here, the creation of the special texture having a target set number i having a value of (n+1) is performed by setting a gray-scale value of 0.0 to the entire coordinates (X, Y) for all of the target texture numbers j ranged from 1 to n to create black beta special textures as shown in the following formula (2).

T_{c,n+1,j}(X,Y)=0.0 (2)

where, c=1 to 3, j=1 to n, X=1 to 2^{b}, Y=1 to 2^{b}

If the special texture of which the target set number i has a value of (n+1) is created, then, n special textures having a vertical stripe pattern corresponding to [i-(n+2)]th bit when the coordinates of the textures are represented as a reflected binary number representation (gray code) for the target set number i are created for each color component based on the following formula (3) (step S160). The target set number i is incremented by 1 (step S170), and the target set number i and the value (n+b+1) are compared with each other (step S180). When the target set number i is equal to or smaller than the value (n+b+1), the process returns to step S160, and the process of creating n special textures for the next target set number i is iterated. When the target set number i is larger than the value (n+b+1), the process advances to the next step. Through the aforementioned process, a matching relationship establishment pattern for establishing a matching relationship between the x-coordinates of the rendered image and the X-coordinates of the special texture is created. Here, the operator “gray(a)” in the formula (3) denotes a gray code representation (reflected binary number code) of the number a, and the operator “and(a, b)” denotes a logical product of each bit of “a” and “b” (as will be similarly used hereinafter). The (n+2)th to (n+b+1)th target set numbers i correspond to the (b−1)th bit (least significant bit) to the 0th bit (most significant bit), respectively, when the coordinates of each texture are represented as a binary number. The special texture having a vertical stripe pattern is created by setting the gray-scale value to 1.0 (white) when the bit value corresponding to the target set number i is 1 and setting the gray-scale value to 0.0 (black) when the corresponding bit number value is 0. According to an embodiment of the invention, the coordinates of the texture are represented as a reflected binary number. For example, if the number n of textures is a value of 3, and the coordinates are represented as 3 bits (b=3) corresponding to a value of 1 to 8, as the special texture having a value of 5 for which the target set number i represents the second bit (least significant bit), a black gray-scale value is set for the X-coordinates value of 1, a white gray-scale value is set for the X-coordinates values of 2 and 3, a black gray-scale value is set for the X-coordinates values of 4 and 5, a white gray-scale value is set for the X-coordinates values of 6 and 7, and a black gray-scale value is set for the X-coordinates value of 8. In addition, as the special texture having a value of 6 for which the target set number i represents the first bit, a black gray-scale value is set for the X-coordinates values 1 and 2, a white gray-scale value is set for the X-coordinates values of 3 to 6, and a black gray-scale value is set for the X-coordinates values 7 and 8. As the special texture having a value of 7 for which the target set number i represents the 0th bit (most significant bit), a black gray-scale value is set for the X-coordinates values of 1 to 4, and a white gray-scale value is set for the X-coordinates values of 5 to 8.

If and(gray(X−1),2ⁱ⁻⁽ⁿ⁺²⁾)≠0, T_{c,i,j}(X,Y)=1.0 or

If and(gray(X−1),2ⁱ⁻⁽ⁿ⁺²⁾)=0, T_{c,i,j}(X,Y)=0.0 (3)

where, c=1 to 3, i=n+2 to n+b+1, j=1 to n, X=1 to 2^{b}, Y=1 to 2^{b}

If the special texture of which the target set number i has a value of (n+2) to (n+b+1) is created, then n special textures having a horizontal stripe pattern corresponding to the [i−(n+b+2)]th bit when the y-coordinates of the textures are represented as a reflected binary number representation for the target set number i are created for each color component based on the following formula (4) (step S185). The target set number i is incremented by 1 (step S190), and the target set number i and the value (n+2b+1) are compared with each other (step S195). When the target set number i is equal to or smaller than the value (n+2b+1), the process returns to step S185, and the process of creating n special textures for the next target set number i is iterated. When the target set number i is larger than the value (n+2b+1), the present routine is terminated because all of the special textures are created. Through the aforementioned process, a matching relationship establishment pattern for establishing a matching relationship between the Y-coordinates of the rendered image and the Y-coordinates of the special texture is created. The (n+b+2)th to (n+2b+1)th target set numbers i correspond to the (b−1)th bit (least significant bit) to the 0th bit (most significant bit), respectively, when the coordinates of each texture are represented as a binary number. The special texture having a horizontal stripe pattern is created by setting the gray-scale value to 1.0 (white) when the bit corresponding to the target set number is 1 and setting the gray-scale value to 0.0 (black) when the corresponding bit number is 0. According to an embodiment of the invention, the coordinates of the texture are represented as a reflected binary number. For example, if the number n of textures is 3, and the y-coordinates are represented as 3 bits (b=3) corresponding to a value of 1 to 8, as the special texture having a value of 8 for which the target set number i represents the second bit (least significant bit), a black gray-scale value is set for the Y-coordinates value of 1, a white gray-scale value is set for the Y-coordinates values of 2 and 3, a black gray-scale value is set for the Y-coordinates values of 4 and 5, a white gray-scale value is set for the Y-coordinates values of 6 and 7, and a black gray-scale value is set for the Y-coordinates value of 8. In addition, as the special texture having a value of 9 for which the target set number i represents the first bit, a black gray-scale value is set for the Y-coordinates values 1 and 2, a white gray-scale value is set for the Y-coordinates values of 3 to 6, and a black gray-scale value is set for the Y-coordinates values 7 and 8. As the special texture having a value of 10 for which the target set number i represents the 0th bit (most significant bit), a black gray-scale value is set for the Y-coordinates values of 1 to 4, and a white gray-scale value is set for the Y-coordinates values of 5 to 8. FIG. 6 illustrates a list of the special textures created when the number n of textures is 3, and the bit number b of the coordinates is 3.

If and(gray(Y−1),2^{i-(n+b+2)})≠0, T_{c,i,j}(X,Y)=1.0 or

If and(gray(Y−1),2^{i-(n+b+2)})=0, T_{c,i,j}(X,Y)=0.0 (4)

where, c=1 to 3, i=n+2 to n+2b+1, j=1 to n, X=1 to 2^{b}, Y=1 to 2^{b}

The rendering processing unit 34 performs the rendering process by attaching the corresponding n special textures for each set to the 3-dimensional model. FIG. 7 illustrates the rendering process. According to an embodiment of the invention, the 3-dimensional model is rendered as a moving picture, the number n of textures is 3, and the bit number is 3. Therefore, the rendering process is performed for a total of 10 sets, and a moving picture corresponding to 10 sets is created. This moving picture includes bitmap images (rendered images) created from each of the frames 1 to T. In addition, in FIG. 7, a bitmap image having a common frame number is extracted from each of the rendered images corresponding to 10 sets and shown in the drawings.

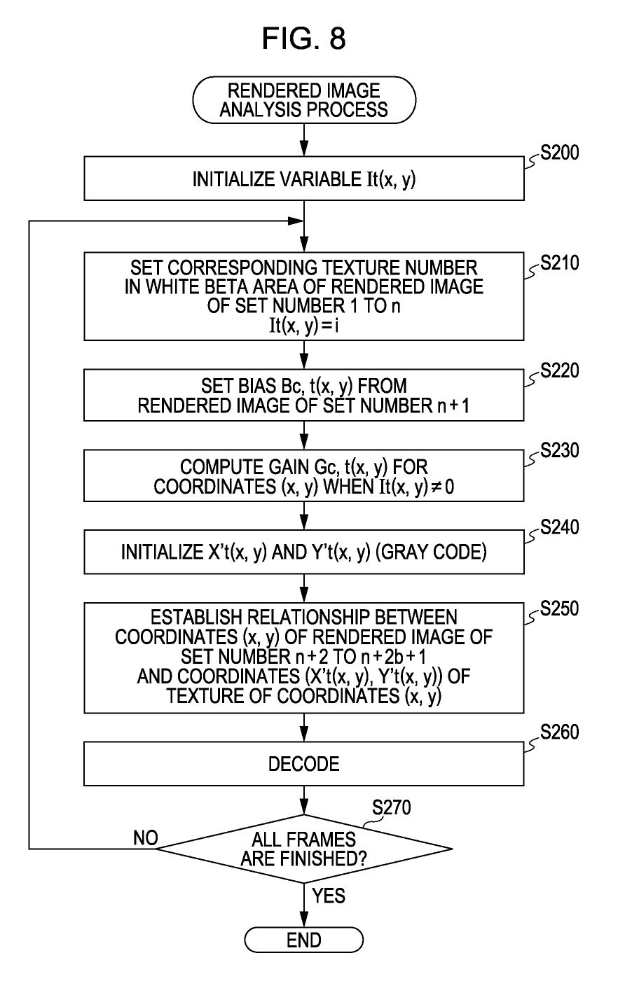

Next, a process of analyzing the rendered image created by the rendering processing unit 34 will be described. FIG. 8 is a flowchart illustrating an example of a rendered image analyzing process performed by the rendered image analysis processing unit 36.

In the rendered image analysis process, first, the variable Iₜ(x, y) representing the texture number attached to the coordinates (x, y) of the rendered image in each frame number t (=1 to T) is initialized to 0 as shown in the following formula (5) (step S200). A white beta area (coordinates) within the rendered image having a set number 1 to n in the target frame t is specified, and a texture number corresponding to the variable Iₜ(x, y) of this white beta area is set (step S210). This process can be performed by comparing the gray-scale value (a total sum of the gray-scale values for each color component) of the rendered image of the target set number i with the gray-scale value (a total sum of the gray-scale values for each color component) of the rendered image of the set number (n+1) while sequentially shifting the target set number i from the first to nth number as shown in the following formula (6). That is, the special texture having the same value of the texture number as the target set number i is set to the white beta, and the special textures of all the texture numbers in the set number (n+1) are set to the black beta. Therefore, when the gray-scale value of the rendered image of the target set number i is larger than the gray-scale value of the rendered image of the set number (n+1), it is considered that the special texture of the texture number i is attached to the coordinates (x, y). Here, the reference symbol “w” in the formula (5) denotes a size of the rendered image in a width direction, and the reference symbol “h” denotes a size in a height direction. In addition, in the formula (6), the reference symbol “A_{c,i,t}(x, y)” denotes a gray-scale value of the coordinates (x, y) of the rendered image, where the reference symbol “c” denotes a color component, the reference symbol i (1 to n) denotes a set number, the reference symbol “t” denotes a frame number (as will be similarly used hereinafter).

Iₜ(x,y)=0 (5)

where, i=1 to n, x=1 to w, y=1 to h
when

$${\sum }_{c = 0}^{2} {A}_{c , n + 1 , t} ( x , y ) < {\sum }_{c = 0}^{2} {A}_{c , i , t} ( x , y ) , {I}_{t} ( x , y ) = i \qquad ( 6 )$$

where, i=1 to n, t=1 to T, x=1 to w, y=1 to h

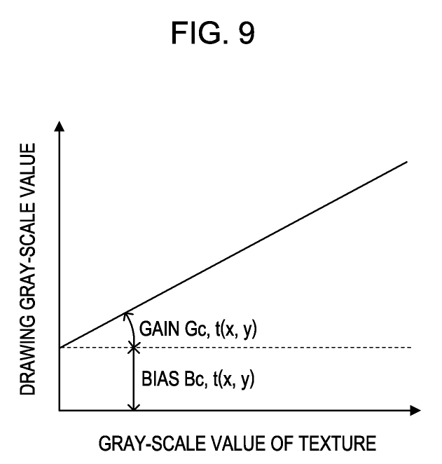

Subsequently, the gray-scale value of the rendered image of the set number (n+1) is set to the bias B_{c,t}(x, y) based on the following formula (7) (step S220), and for the coordinates (x, y) of the rendered image having a variable Iₜ(x, y) which is not zero, i.e., the area where the texture is attached, the gain G_{c,t}(x, y) is computed based on the following formula (8) (step S230). Here, in the formula (8), the reference symbol “A_{c,It(x,y),t}(x,y)” denotes the gray-scale value of the coordinate (x, y) of the rendered image stored in the variable It(x,y) for the color component c, the set number i, and the frame number t. FIG. 9 illustrates a relationship between the bias B_{c,t}(x, y) and the gain G_{c,t}(x, y). When the 3-dimensional model is rendered by attaching the texture, as shown in the drawings, the offset that does not depend on the original gray-scale value corresponds to the bias B_{c,t}(x, y), and the inclination of the variation of the gray-scale value of the rendered image against the variation of the gray-scale value of the original texture corresponds to the gain G_{c,t}(x,y).

B_{c,t}(x,y)=A_{c,n+1,t}(x,y) (7)

If Iₜ(x,y)≠0, G_{c,t}(x,y)=A_{c,It(x,y),t(}x,y)−B_{c,t}(x,y) or

If Iₜ(x,y)=0, G_{c,t}(x,y)=0 (8)

where, c=1 to 3, t=1 to T, x=1 to w, y=1 to h

In addition, based on the following formula (9), the coordinates (X′ₜ(x, y), Y′ₜ(x, y)) which are a gray-code representation of the texture are initialized to 0 (step S240). A matching relationship between the coordinates (x, y) of the rendered image of the set numbers (n+2) to (n+2b+1) and the coordinates (X′ₜ(x, y), Y′ₜ(x, y)) of the texture is established (step S250). Here, the matching relationship of the coordinates is established by the following formula (10). Specifically, it is determined whether a value (a total sum for each color component) obtained by subtracting the bias B_{c,t}(x, y) from the gray-scale value A_{c,i+n+1,t}(x, y) of the rendered image of the set number (i+n+1) while sequentially shifting the number i from the first to the bth number i is larger than a value (a total sum for each color component) obtained by dividing by 2 the gain G_{c,t}(x, y) of the rendered image of the set number i, i.e., whether or not the coordinates (x, y) are black within the vertical stripe pattern having black and white colors in the set number (i+n+1). If it is determined that the value is white, the (i−1)th bit corresponding to the coordinates X′ₜ(x, y) which is a reflected binary number representation is set to 1. It is determined whether or not a value (a total sum for each color component) obtained by subtracting the bias Bc,t(x, y) from the gray-scale value A_{c,i+b+n+1,t}(x, y) of the rendered image of the set number (i+b+n+1) while sequentially shifting the number i from the first to the bth number is larger than a value (a total sum for each color component) obtained by dividing the gain G_{c,t}(x, y) of the rendered image of the set number i by 2, i.e., whether or not a value of the coordinates (x, y) in the set number (i+b+n+1) is white within the horizontal stripe pattern including white and black colors. If it is determined that the value is white, the (i−1)th bit corresponding to the coordinates Y′ₜ(x, y) is set to 1. Here, the operator “or(a, b)” represents a logical sum for each bit of the “a” and “b” within the formula (10).

X′ₜ(x,y)=0 (9)

Y′ₜ(x,y)=0

where, t=1 to T, x=1 to w, y=1 to h
when

$$\frac{{\sum }_{c = 0}^{2} {G}_{c , t} ( x , y )}{2} < {\sum }_{c = 0}^{2} {A}_{c , i + n + 1 , t} ( x , y ) - {\sum }_{c = 0}^{2} {B}_{c , t} ( x , y ) , \\ {X}_{t}^{′} ( x , y ) = or ( {X}_{t}^{′} ( x , y ) , {2}^{i - 1} ) \\ when \\ \frac{{\sum }_{c = 0}^{2} {G}_{c , t} ( x , y )}{2} < {\sum }_{c = 0}^{2} {A}_{c , i + b + n + 1 , t} ( x , y ) - {\sum }_{c = 0}^{2} {B}_{c , t} ( x , y ) , \\ {Y}_{t}^{′} ( x , y ) = or ( {Y}_{t}^{′} ( x , y ) , {2}^{i - 1} ) \qquad ( 10 )$$

where, i=1 to b, t=1 to T, x=1 to w, y=1 to h

As the matching relationship of the coordinates is established, the coordinates (X′ₜ(x, y), Y′ₜ(x, y)) of the texture which is a gray code representation is decoded using the following formula (11), and the coordinates value (X′ₜ(x, y), Y′ₜ(x, y)) after the decoding is computed (step S260). It is determined whether or not the process has been completed for all of the frames 1 to T (step S270). If the process has not been completed for all of the frames, the process returns to step S210 and is iterated by setting the next frame as a target frame t. If the process has been completed for all of the frames, the process is terminated. Here, the “gray−1(a)” in the formula (11) represents a value obtained by decoding the gray code a. The “Xₜ(x, y)” denotes x-coordinates of the texture corresponding to the coordinates (x, y) of the rendered image of the frame number t. The “Yₜ(x, y)” denotes y-coordinates of the texture corresponding to the coordinates (x, y) of the rendered image of the frame number t. In addition, according to an embodiment of the invention, since the origin of the coordinates (X′ₜ(x, y), Y′ₜ(x, y)) is set to (1, 1), a value of 1 is added to the value obtained by decoding the gray code. As the image portrayal information, there are included the variable Iₜ(x, y), the bias B_{c,t}(x, y), the gain G_{c,t}(x, y), and the coordinates (Xₜ(x, y), Yₜ(x, y)).

Xₜ(x,y)=gray⁻¹(X′ₜ(x,y))+1 or

Yₜ(x,y)=gray⁻¹(Y′ₜ(x,y))+1 (11)

where, t=1 to T, x=1 to w, y=1 to h

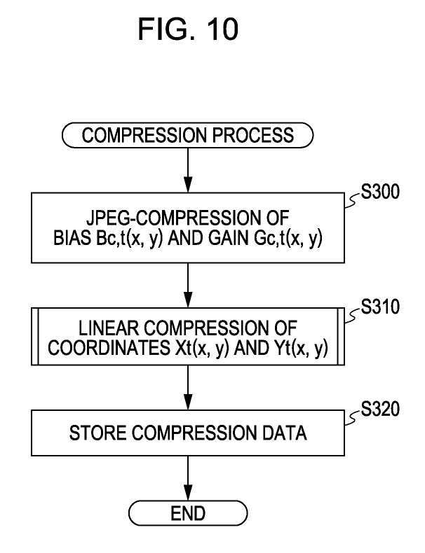

Next, a process of compressing the image portrayal information obtained by analysis of the rendered image analysis processing unit 36, particularly, a process of compressing the coordinates (Xₜ(x, y), Yₜ(x, y)) will be described. FIG. 10 is a flowchart illustrating an example of a compression process executed by the compression processing unit 38.

In the compression process, first, the bias B_{c,t}(x, y) and the gain G_{c,t}(x, y) are compressed using a JPEG compression scheme (step S300). Next, the coordinates (Xₜ(x, y), Yₜ(x, y)) are compressed using a linear compression scheme (step S310), and the compressed data are stored (step S320), so that the present routine is terminated. The aforementioned compression process may be performed for any one or both of the areas by dividing the texture area where the texture is attached and the non-texture area where the texture is not attached. In addition, the variable Iₜ(x, y) may be compressed as the image portrayal information.

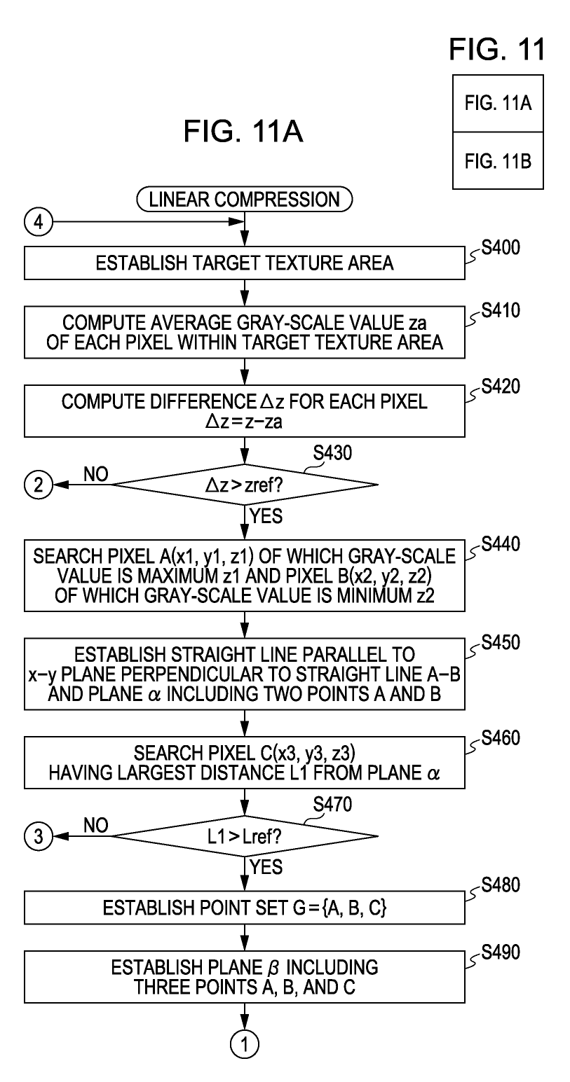

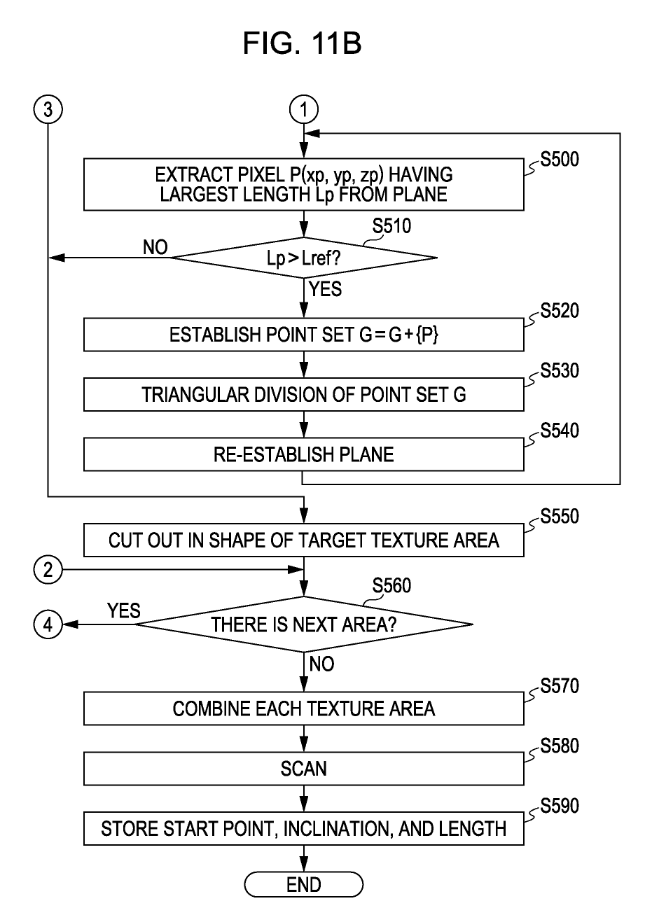

FIG. 11 is a flowchart illustrating an example of the linear compression process executed in step S310 of FIG. 10. The linear compression process according to an embodiment of the invention is a linear approximation using a triangulation for each of the coordinates Xₜ(x, y) and Yₜ(x, y) of the rendered image. That is, in a graph obtained by setting the coordinates value Xt as a height on the x-y plane, the upper space of the x-y plane is covered by a plurality of triangles approximated to this height, and a difference between a plurality of the triangles and the coordinates value Xₜ is set to be equal to or smaller than a predetermined criteria. In addition, the surface of the corresponding triangle is considered to have a coordinates value Xₜ in the coordinates (x, y). Specifically, first, a target texture area is established (step S400). In other words, since the coordinates value Xₜ(x, y) is defined only for the coordinates (x, y) under the condition that Iₜ(x, y)≠0, i.e., the coordinates where the texture is attached, in this case, a single area satisfying the condition Iₜ(x, y)≠0 out of all of the coordinates (x, y) is set as a target texture area. In addition, if there is only a single area satisfying the condition Iₜ(x, y)≠0, this single area is set as the target texture area. If there are a plurality of areas satisfying the condition Iₜ(x, y)≠0 in separation from the x-y plane, each of the areas is set as the target texture area. Then, the process subsequent to step S410 is performed for each target texture area. In addition, while the linear compression is applied to each of the coordinates Xₜ(x, y) and Yₜ(x, y) for the texture area in the present embodiment, an arbitrary coordinates value Xₜ, Yₜ may be set to the non-texture area, and the linear compression may be collectively performed for all of the coordinates (x, y).

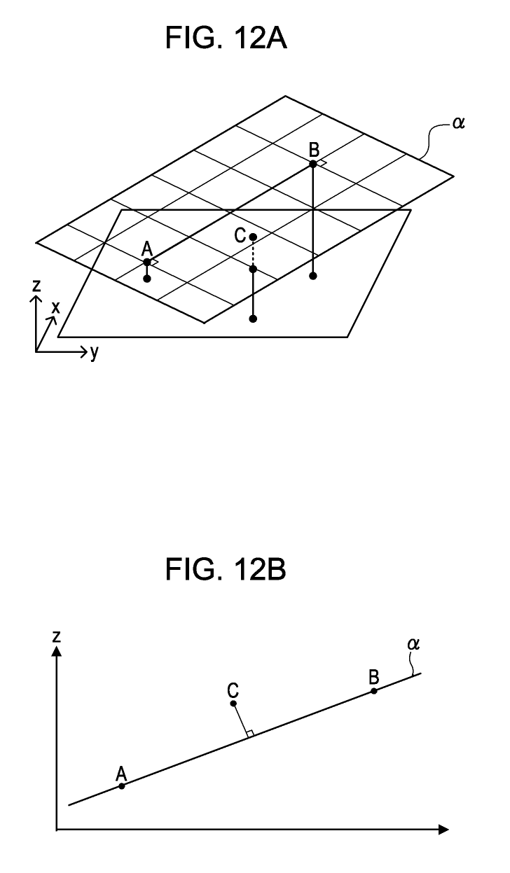

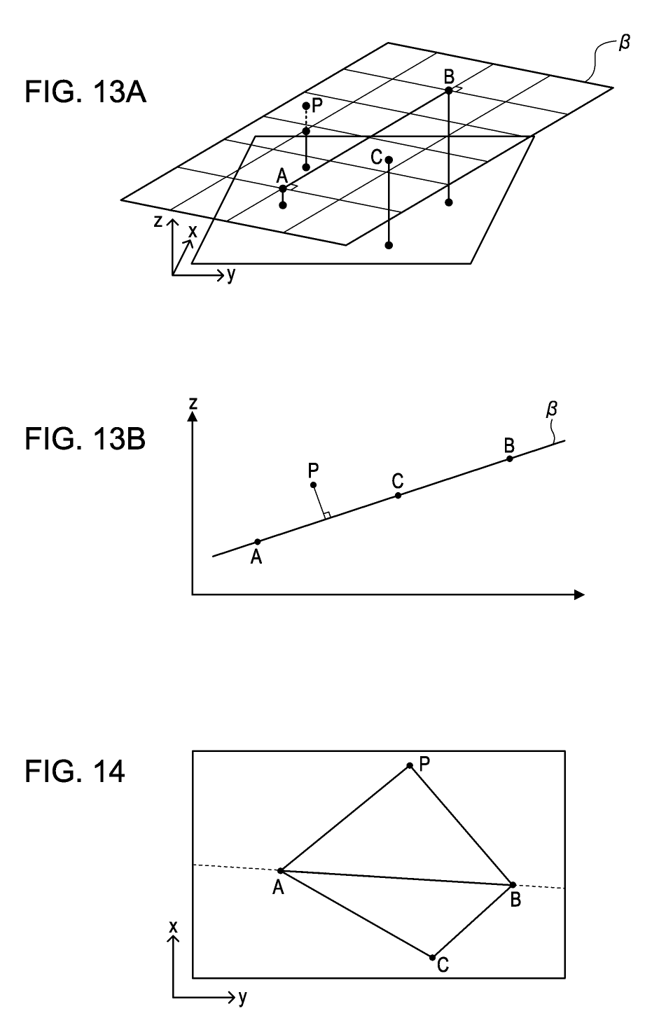

As the target texture area is set, an average gray-scale value za is computed by obtaining an average of the gray-scale value z (the coordinates value Xₜ or Y) within this target texture area (step S410). At the same time, a difference Δz between the average gray-scale value za and the gray-scale value z at each pixel within the target texture area is computed (step S420), and it is determined whether or not the computed difference Δz is larger than the threshold value zref (step S430). If the difference Δz at any pixel is equal to or smaller than the threshold value zref, it is determined whether or not the next texture area exists (step S560). If the next texture area exists, the process returns to step S400 and is iterated by setting this texture area as the target texture area. If the difference Δz at any pixel is larger than the threshold value zref, a pixel A(x1, y1, z1) where the gray-scale value has a maximum z1 and a pixel B(x2, y2, z2) where the gray-scale value has a minimum z2 are searched (step S440), and a plane a including two points A and B and a straight line perpendicular to the line A-B and parallel to the x-y plane is established (step S450). A pixel C(x3, y3, z3) having a largest length L1 from the established plane α is searched (step S460). FIG. 12 illustrates a relationship between the plane α and the pixel C. As the pixel C is searched through the aforementioned process, it is determined whether or not the length L1 is larger than the threshold value Lref (step S470). If it is determined that the length L1 is equal to or smaller than the threshold value Lref, the process advances to the subsequent step. If it is determined that the length L1 is larger than the threshold value Lref, a point set G={A, B, C} is established (step S480), and a plane β including three points A, B, and C is established (step S490). FIG. 13 illustrates a relationship between the plane β and the pixel P. Next, a pixel P(xp, yp, zp) having the largest length Lp from the plane is searched (step S500). In addition, when the step S500 is initially executed, the plane functioning as a computation target of the length Lp is the plane β established in step S490. If the step S500 is executed after the second turn, the plane functioning as a computation target of the length Lp is the plane re-established in the step S540.

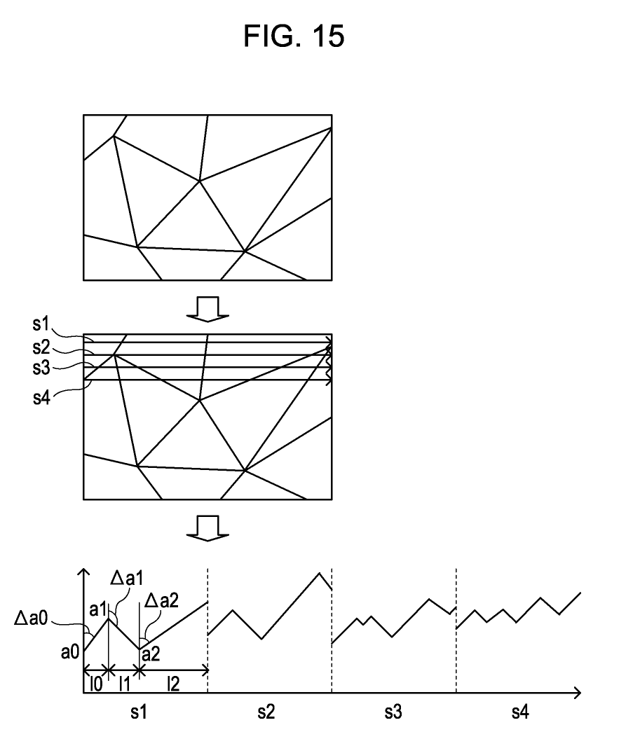

Then, it is determined whether or not the length Lp is larger than the threshold value Lref (step S510). If it is determined that the length Lp is equal to or smaller than the threshold value Lref, the process advances to the subsequent step. If it is determined that the length Lp is larger than the threshold value Lref, the point set G is established by newly adding the pixel P (step S520). A triangulation is performed for the established point set G (step S530), and the plane is re-established (step S540). FIG. 14 illustrates a process of the triangulation for the point group G={A, B, C, P}. As shown in FIG. 14, a triangular plane including three points A, B, and C and a triangular plane including three points A, B, and P are divided by a straight line A-B shared by both triangular planes, and the plane is re-established by extending each of the triangular planes using the straight line A-B as a boundary. As the plane is re-established, the process returns to the step S500, so that the pixel P(xp, yp, zp) having the largest length Lp from the re-established plane is searched (step S510), and the process of steps S500 to S540 is iterated until the length Lp is equal to or smaller than the threshold value Lref. If the length Lp is equal to or smaller than the threshold value Lref in the step S510, the established plane is cut out in the shape of the target texture area (step S550). If the next texture area exists (step S560), the process returns to the step S400, and the process of the steps S400 to S560 is iterated by setting this texture area as the target texture area. If the next texture area does not exist, the planes cut out from each texture area are combined (step S570). This combined plane is sequentially scanned in the x-coordinates direction for each column (the y-coordinates direction) (step S580), and the start point a, the inclination Δa, the length I obtained therefrom are stored (step S590), so that the present process is terminated. Information representing the stored start point a, the inclination Δa, and the length I is the information representing the linearly compressed coordinates Xₜ(x, y) or Yₜ(x, y). FIG. 15 illustrates a process of the linear compression. The linear compression is performed, as shown in the drawings, by obtaining the start points a0, a1, and a2, the inclinations Δa0, Δa1, and Δa2, and the lengths 10, 11, and 12 for the scanning line S1, iterating this process for each scanning lines s2 and s3, and storing the results.

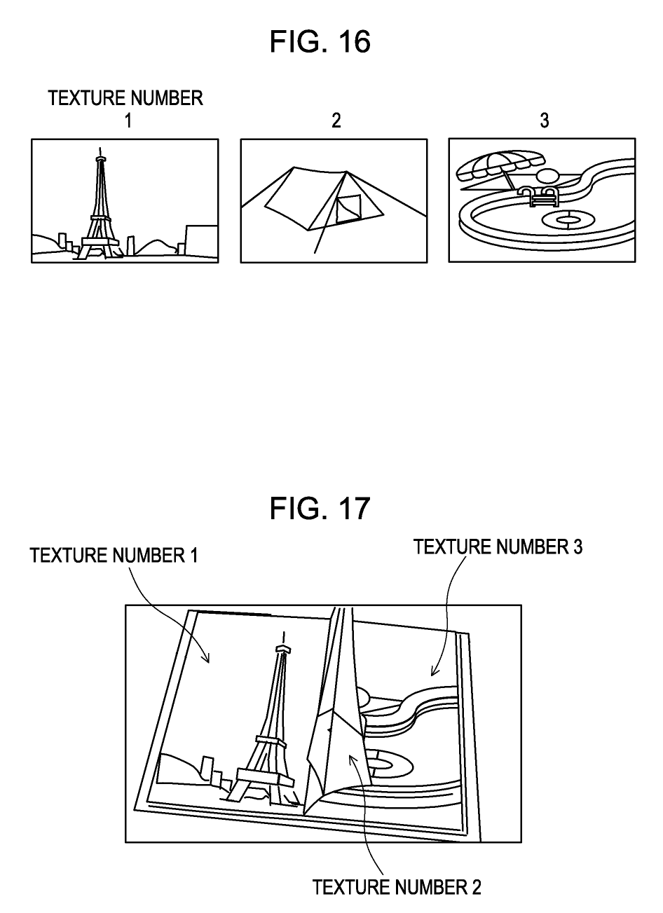

The image portrayal information such as the bias B_{c,t}(x, y), the gain G_{c,t}(x, y), the coordinates Xₜ(x, y) and Yₜ(x, y)), and the variable Iₜ(x, y) compressed by the compression processing unit 38 of the computer 20 is stored in the storage unit 41 of the viewer 40 and decompressed using the deployment processing unit 44 of the viewer 40 by performing a linear decompression process for the linearly compressed coordinates Xₜ(x, y) and Yₜ(x, y) and performing a JPEG decompression process for the bias B_{c,t}(x, y) and the gain G_{c,t}(x, y) that was compressed using a JPEG compression scheme. The resultant image portrayal information is used in the portrayal process in the portrayal processing unit 46. The portrayal processing unit 46 reads a plurality of image data such as a photograph stored in the memory card MC as the replacement texture, and synthesizes and sequentially portrays it on the rendered image using the following formula (12) so that a slideshow display in which the rendered image of the 3-dimensional model is displayed while replacing the texture can be performed. Here, in the formula (12), the “U_{c,It(x,y)}(Xt(x, y), Yt(x, y))” denotes the gray-scale value (0.0 to 1.0) of the coordinates (X, Y) of the replacement texture for the color component c and the texture number i, and the “P_{c,t}(x, y)” denotes the gray scale value (0.0 to 1.0) of the coordinates (x, y) of the display image (rendered image) for the color component c and the frame number t. As shown in the formula (12), the gray-scale value P_{c,t}(x, y) of the display image is set by setting a value obtained by multiplying the gray-scale value of the replacement texture coordinates (Xₜ(x, y), Yₜ(x, y)) corresponding to the coordinates (x, y) of the display image by the gain G_{c,t}(x, y) and adding the bias B₀(x, y) thereto for the texture arrangement area where the variable Iₜ(x, y) is not 0. FIG. 16 illustrates three replacement textures having texture numbers 1 to 3, and FIG. 17 illustrates a process of arranging and portraying the replacement texture of FIG. 16 on the rendered image. As described above, since the linear compression scheme is used for the coordinates Xₜ(x, y) and Yₜ(x, y), it is possible to suppress a data amount with a relatively high compression rate as well as to suppress image degradation when the replacement texture is arranged.

If Iₜ(x,y)≠0,

P_{c,t}(x,y)=B_{c,t}(x,y)+G_{c,t}(x,y)U_{c,It(x,y)}(Xₜ(x,y),Yₜ(x,y)) or

If Iₜ(x,y)=0,

P_{c,t}(x,y)=B_{c,t}(x,y) (12)

where, c=1 to 3, t=1 to T, x=1 to w, y=1 to h

In the image processing method described above according to an embodiment of the invention, the rendering is performed by attaching the special texture to the 3-dimensional model, and image portrayal information (Xₜ(x, y), Yₜ(x, y)) representing a matching relationship between the coordinates(x, y) and the coordinates (X, Y) of the texture as an example of the image portrayal information obtained analyzing the rendered image is compressed using a linear compression scheme. Therefore, it is possible to compress data with a high compression rate while suppressing degradation of the entire image quality. In the computer 20 side, the rendering is performed by attaching, to the 3-dimensional model, the vertical stripe pattern for the x-coordinates and the horizontal stripe pattern for the y-coordinates as the special texture corresponding to each bit when the coordinates (X, Y) is expressed as a binary number, and the rendered image obtained as the bitmap image through the rendering is analyzed, so that a matching relationship between the coordinates (x, y) of the rendered image and the coordinates (Xₜ(x, y), Yₜ(x, y)) of the texture is established and stored as image portrayal information. When the viewer 40 displays the image using the rendered image, the image is portrayed at the coordinates (x, y) of the display image based on the gray-scale value of the coordinates (Xₜ(x, y), Yₜ(x, y)) of the texture and the image portrayal information that has been previously stored. Therefore, it is possible to reproduce the rendered image of the 3-dimensional model by freely exchanging the texture and reduce a processing burden in comparison with the method of rendering and displaying the 3-dimensional model in real-time. Furthermore, since the gray-scale value of the display image is set by converting the gray-scale value of the texture using the gain G_{c,t}(x, y) or the bias B_{c,t}(x, y), it is possible to express influence from refraction light, mirror reflection, shades, or the like when the 3-dimensional model is rendered. Furthermore, the horizontal stripe pattern and the vertical stripe pattern corresponding to the reflected binary number are formed as the special texture for specifying a matching relationship of the coordinates. Therefore, it is possible to suppress erroneous data that may be obtained due to the errors in the gray scale value of the image because a single bit always changes in order to advance to the neighboring coordinates.

While the coordinates Xₜ(x, y) and Yₜ(x, y) are compressed using a linear compression scheme according to an embodiment of the invention, the invention is not limited thereto, but the bias B_{c,t}(x, y) or the gain G_{c,t}(x, y) may be compressed using a linear compression. In addition, the coordinates system for the linear compression may be the x-y coordinates system. That is, the matching relationship of the coordinates may be defined as xₜ(X, Y) and yₜ(X, Y), and the height xₜ or yₜ on the X-Y plane may be expressed by a linear approximation using a triangulation. Instead of the aforementioned JPEG compression scheme, other compression schemes such as JPEG2000, GIF, TIFF, and a lossless compression process such as a deflate compression may be used in the compression.

According to an embodiment of the invention, the vertical stripe pattern for the x-coordinates and the horizontal stripe pattern for the y-coordinates corresponding to each bit when the coordinates (X, Y) are represented as a binary number are used as the texture to perform the rendering by attaching them to the 3-dimensional model and analyze the rendering result so as to create the image portrayal information. However, the used pattern is not limited thereto, but a pattern in which the density (gray-scale value) gradually changes in the x-coordinates direction (horizontal direction) and a pattern in which the density gradually changes in the y-coordinates direction (vertical direction) may be used. In this case, instead of the vertical stripe patterns having set numbers (n+2) to (n+b+1) obtained by the aforementioned formula (3), a single pattern having a set number (n+2) obtained by the following formula (13) may be used. At the same time, instead of the horizontal stripe pattern having set numbers (n+b+2) to (n+2b+1) obtained by the formula (4), a single pattern having a set number (n+3) obtained by the following formula (14) may be used.

T_{c,n+2,j}(X,Y)=X−1/2^{b} (13)

T_{c,n+3,j}(X,Y)=Y−1/2^{b} (14)

where, c=1 to 3, j=1 to n, X=1 to 2^{b}, Y=1 to 2^{b}

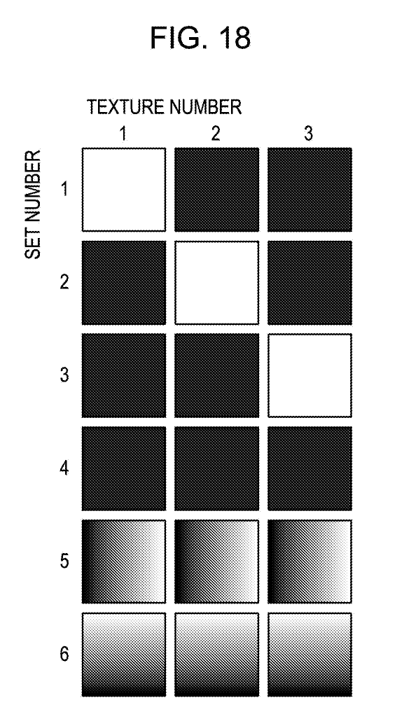

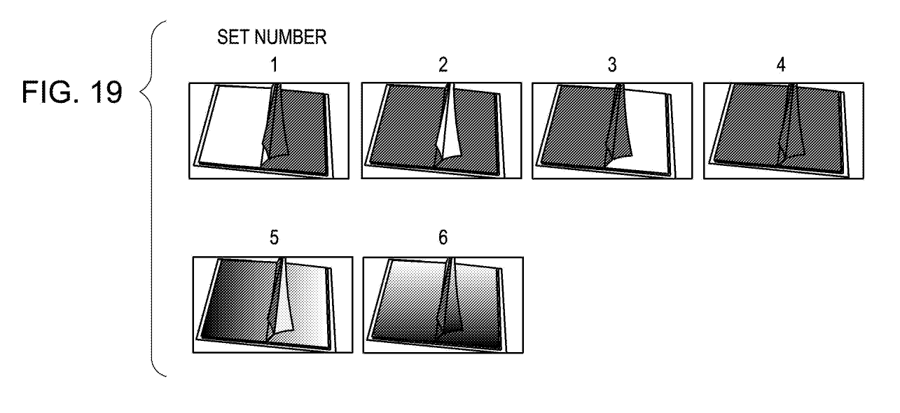

When the pattern of the formula (13) and the pattern of the formula (14) are used, the matching relationship of the coordinates may be established by the following formula (15). FIG. 18 illustrates an example of the special texture, and FIG. 19 illustrate a process of performing the rendering by attaching the special texture of FIG. 18 to the 3-dimensional model. As a result, it is possible to reduce the number of special textures to be created.

$${X}_{t} ( x , y ) = \frac{{\sum }_{c = 0}^{2} {A}_{c , n + 2 , t} ( x , y ) - {\sum }_{c = 0}^{2} {B}_{c , t} ( x , y )}{{\sum }_{c = 0}^{2} {G}_{c , t} ( x , y )} \times {2}^{b} + 1 \\ {Y}_{t} ( x , y ) = \frac{{\sum }_{c = 0}^{2} {A}_{c , n + 3 , t} ( x , y ) - {\sum }_{c = 0}^{2} {B}_{c , t} ( x , y )}{{\sum }_{c = 0}^{2} {G}_{c , t} ( x , y )} \times {2}^{b} + 1 \qquad ( 15 )$$

where, t=1 to T, x=1 to w, y=1 to h

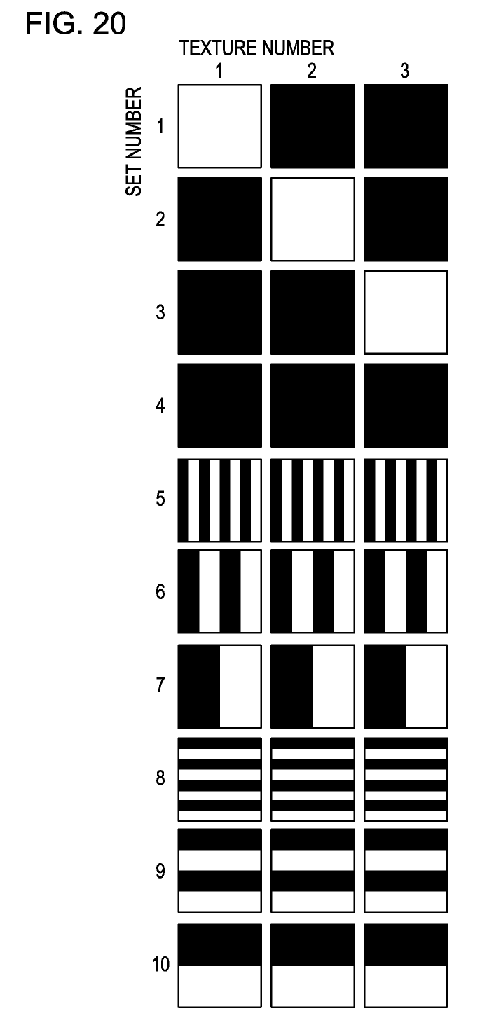

According an embodiment of the invention, the special texture of the vertical stripe pattern having a target set number i of (n+2) to (n+b+1) corresponds to each bit obtained by representing the coordinates by the reflected binary numbers. At the same time, the special texture of the horizontal stripe pattern having a target set number i of (n+b+2) to (n+2b+1) corresponds to each bit obtained by representing the coordinates by the reflected binary numbers. However, such patterns may correspond to each bit value obtained by representing the coordinates by general binary numbers. An example of the special texture in this case is shown in FIG. 20.

While the image is reproduced using the viewer 40 according to an embodiment of the invention, any device such as a mobile phone or a printer having a liquid crystal display screen that can reproduce an image may be used.

In addition, the present invention is not limited to the aforementioned embodiments, but may be embodied in various forms without departing from the spirit and the scope of the invention.

What is claimed is:

1. An image processing method comprising:
obtaining image portrayal information representing a relationship between coordinates of a rendered image obtained by performing rendering with a texture attached to a 3-dimensional model and coordinates of the texture and a relationship between colors of each pixel of the rendered image and colors of each pixel of the texture; and
compressing the image portrayal information representing a relationship between coordinates of the rendered image and coordinates of the texture using a linear compression scheme.

2. The image processing method according to claim 1, wherein the image portrayal information representing a relationship between colors of each pixel of the rendered image and colors of each pixel of the texture is compressed using a JPEG compression scheme.

3. The image processing method according to claim 1, wherein in the linear compression scheme, data are compressed by linearly approximating any one of the coordinates of the rendered image or the coordinates of the texture using a triangulation.

4. The image processing method according to claim 1, wherein the rendering is performed by attaching a predetermined pattern where a different gray-scale value is set for each of the coordinates as the texture to the 3-dimensional model,
a relationship between the coordinates of the rendered image and the coordinates of the texture is established by analyzing the rendered image obtained as a bitmap image through the rendering and stored as the image portrayal information, and
when a desired texture is displayed as an image, the desired texture is arranged and displayed on the rendered image based on the stored image portrayal information.

5. The image processing method according to claim 4, wherein the matching relationship is derived by specifying corresponding coordinates having a predetermined pattern from gray-scale values of each of the coordinates of the rendered image.

6. The image processing method according to claim 4, wherein the number of the predetermined patterns is the same as a bit number obtained by representing the coordinates of the texture as a binary number,
each of the patterns corresponds to each bit obtained by representing coordinates of each pattern as a binary number, and
a gray-scale value of each of the coordinates of each pattern is set to a value corresponding to the corresponding bit number.

7. The image processing method according to claim 6, wherein the binary number is a gray code (reflected binary number).

8. The image processing method according to claim 4, wherein the rendering is performed by attaching, to the 3-dimensional model, a first solid painting pattern obtained by performing solid painting using a minimum gray-scale value in addition to a matching relationship establishment pattern for establishing a matching relationship between coordinates of the rendered image and coordinates of the texture as a predetermined pattern,
a bias value which is a gray-scale value of the first solid painting pattern in the rendered image is stored as the image portrayal information representing a relationship between the colors of each pixel of the rendered image and colors of each pixel of the texture, and
the rendered image is displayed by converting the gray-scale value of the desired texture into the gray-scale value of the rendered image by offsetting the gray-scale value of the desired texture based on the stored bias value.

9. The image processing method according to claim 8, wherein the bias value is compressed using a linear compression scheme.

10. The image processing method according to claim 4, wherein the rendering is performed by attaching, to the 3-dimensional model, a first solid painting pattern obtained by performing a first solid painting using a minimum gray-scale value and a second solid painting pattern obtained by performing a second solid painting using a maximum gray-scale value in addition to a matching relationship establishment pattern for establishing a relationship between coordinates of the rendered image and coordinates of the texture as the predetermined pattern,
a gain which is a difference between gray-scale values of the first and second solid painting patterns in the rendered image is computed and stored as the image portrayal information representing a matching relationship between colors of each pixel of the rendered image and colors of each pixel of the texture, and
the gray-scale value of the desired texture is converted into the gray-scale value of the rendered image based on the stored gain and displayed.

11. The image processing method according to claim 10, wherein, when the rendered image is displayed by arranging n textures (where n is a natural number) thereon, the rendering is performed by setting n sets including (n−1) first solid painting patterns and a single second solid painting pattern and attaching, to the 3-dimensional model, each set including a first set group in which an area where the second solid painting pattern is attached to the 3-dimensional model is different for each set and a second set including n first solid painting patterns, and
wherein a texture area where the texture is attached to the 3-dimensional model is specified by comparing, for each set of the first set group, gray-scale values of each rendered image obtained by performing the rendering for each set of the first set group with gray-scale values of the rendered image obtained by performing the rendering for the second set, and the gain is computed for the specified texture area.

12. The image processing method according to claim 1, wherein the image is portrayed on a frame basis and displayed as a moving picture.

13. An image processing apparatus comprising:
an image portrayal information obtainment unit that obtains image portrayal information representing a matching relationship between coordinates of a rendered image obtained by performing rendering with a texture attached to a 3-dimensional model and coordinates of the texture and a matching relationship between colors of each pixel of the rendered image and colors of each pixel of the texture; and
a compression unit that compresses the image portrayal information representing coordinates of the rendered image and coordinates of the texture using a linear compression scheme.
